(19) United States
(12) Patent Application Publication
(10) Pub. No.: US 2016/0148259 A1
(43) Pub. Date: May 26, 2016

(54) METHOD OF MANAGING COOKIE INFORMATION FOR TARGET ADVERTISEMENT AND APPLICATION FOR MANAGING COOKIE INFORMATION

(71) Applicant: MEZZOMEDIA CO., LTD., Seongnam-si (KR)

(72) Inventors: Si Young BAEK, Namyangju-si (KR); Young Hwan WOO, Seoul (KR); Jong Pil JUNG, Seoul (KR); Nam Hong KIM, Namyangju-si (KR)

(21) Appl. No.: 14/952,300

(22) Filed: Nov. 25, 2015

(30) Foreign Application Priority Data
Nov. 25, 2014 (KR) 10-2014-0165425

(51) Int. Cl. G06Q 30/02; H04L 29/08

(52) U.S. Cl. CPC G06Q 30/0255; H04L 67/02; H04L 67/146

(57) ABSTRACT

The present invention relates to a method of managing cookie information in a user terminal and an application thereof. Specifically, the present invention relates to a cookie information management method and an application thereof, which can provide information needed for target advertisement to a service server in the future by matching a subject using an application and a subject using a web in the user terminal as one user using cookies and, furthermore, allowing the user terminal to integratedly manage the cookie information according to using an application and a web.

### BACKGROUND OF THE INVENTION

1. Field of the Invention

The present invention relates to a method of managing cookie information in a user terminal and an application thereof. Specifically, the present invention relates to a cookie information management method and an application thereof, which can provide information needed for target advertisement to a service server in the future by matching a subject using an application and a subject using a web in the user terminal as one user using cookies and, furthermore, allowing the user terminal to integratedly manage the cookie information according to using an application and a web.

2. Background of the Related Art

Owing to remarkable development of mobile communication networks and mobile communication terminals, recently, users can do a variety of works through a terminal without constraints of space, and the use time and distribution rate of user terminals also increase exponentially in proportion to the degree of development.

As such a so-called mobile communication environment is constructed, a marketing methodology using the environment is also spotlighted greatly, and studies on further efficient marketing methods using the mobile communication environment are progressed continuously.

On the other hand, although the marketing, i.e., an advertisement, chiefly conducted in a conventional mobile communication environment has been accomplished in a method of simply displaying advertisement contents (playback or pop-up of an image, a video or the like) targeting unspecified many people, such an advertisement method only resulted in negative impressions of users on the advertisement, such as making a user feel reluctance to the advertisement or hindering the user from using a mobile service.

In order to maximize the advertisement effect in the mobile communication environment, a marketing methodology of grasping the types of advertisements connected by a user on a terminal, categories of web pages frequently connected by the user and the like, i.e., grasping a web page connection pattern of the user terminal, and providing the user with an appropriate advertisement at an appropriate time is spotlighted recently, and, accordingly, ideas for a method of collecting information for grasping the web page connection pattern of the user terminal are diversely introduced.

On the other hand, in order to collect information needed for marketing from the user terminal, the information should be collected based on identification information individually assigned to each terminal, and identification information, which is generally used, has unique identification information (a serial number, a terminal UDID or the like) stored in each terminal and an advertisement ID provided by the operating system (OS) of the terminal. However, such a kind of terminal identification information can be collected only by an application installed in the user terminal, i.e., an application which has a source code in itself and controls the user terminal through the source code, and the terminal identification information cannot be collected by a web browser, i.e., the web browser which controls the user terminal through a script when connecting to a web page.

As a result, since the user terminal cannot acquire the terminal identification information through a web browser most frequently used by users although the terminal identification information can be acquired through an application, there is a problem in that an advertisement connection pattern of a user cannot be effectively grasped.

Accordingly, required is a methodology of collecting the terminal identification information even when a web browser is used on a user terminal.

### SUMMARY OF THE INVENTION

Therefore, the present invention has been made in view of the above problems, and it is an object of the present invention to provide a cookie information management method and an application thereof, in which an advertisement connection is recognized as being originated from one user terminal regardless of whether the advertisement connection is an advertisement connection through an application or an advertisement through a web browser by managing cookies so that the user terminal may share cookie information between when an advertisement selection is input through the application and when an advertisement selection is input through the web browser.

Particularly, an object of the present invention is to provide a cookie information management method and an application thereof, which can specify a subject of an advertisement connection through an application or a subject of an advertisement connection through a web browser as one user terminal by allowing the application and the web browser to share a cookie created by execution of the application and a cookie created by connection to a web page and freely update internal cookie information.

To accomplish the above objects, according to one aspect of the present invention, there is provided a cookie information management method including the steps of: (a) receiving an advertisement selection input of a user for a specific advertisement, on an application of a user terminal; (b) acquiring terminal identification information of the user terminal; and (c) creating or updating a cookie including the terminal identification information.

In addition, after the step of acquiring terminal identification information of the user terminal, the cookie information management method further includes the step of confirming whether or not a previously created cookie corresponding to the advertisement and including temporary identification information exists in the user terminal.

At this point, if a previously created cookie exists as a result of the confirmation, step (c) may load the previously created cookie, conduct mapping of the terminal identification information and the temporary identification information, and update the cookie information by recording the mapped terminal identification information in the cookie, and if a previously created cookie does not exist, step (c) creates a new cookie including the terminal identification information.

On the other hand, in the cookie information management method, the terminal identification information includes at least any of a serial number, a Unique Device ID (UDID) and an advertisement identifier of each OS.

In addition, in the cookie information management method, the step of acquiring terminal identification information of the user terminal may be implemented to further acquire additional information of the user terminal including at least any one of an IP address of the terminal, a communication company, a type of an operating system, a version of the operating system, a network, a language set in the terminal, a manufacturer of the terminal, a model name of the terminal, a resolution of the terminal and a type of the terminal.

In addition, in the cookie information management method, the cookie is created by a control command of a software development kit installed in the user terminal.

In addition, the cookie information management method may further include the step of transmitting the cookie information included in the cookie.

At this point, the cookie information includes web page connection information or advertisement connection information.

On the other hand, according to another aspect of the present invention, there is provided a cookie information management method including the steps of: (a) receiving an advertisement selection input of a user for a specific advertisement, on a web browser of a user terminal; (b) connecting to a web page corresponding to the advertisement selection input; and (c) creating temporary identification information and creating or updating a cookie including the temporary identification information.

In addition, after the step of connecting to a web page corresponding to the advertisement selection input, the cookie information management method further includes the step of confirming whether or not a previously created cookie corresponding to the advertisement and including terminal identification information exists in the user terminal.

At this point, if a previously created cookie exists as a result of the confirmation, step (c) loads the previously created cookie, conducts mapping of the temporary identification information and the terminal identification information, and updates the cookie information by recording the mapped temporary identification information in the cookie, and, contrarily, if a previously created cookie does not exist, step (c) creates a new cookie including the temporary identification information.

In addition, in the cookie information management method, the terminal identification information may include at least any of a serial number, a Unique Device ID (UDID) and an advertisement identifier of each OS.

In addition, in the cookie information management method, the cookie is created by a control command of a script when the web page corresponding to the advertisement selection input is connected.

In addition, the cookie information management method may further include the step of transmitting the cookie information included in the cookie, and, at this point, the cookie information includes web page connection information or advertisement connection information.

On the other hand, an application according to still another embodiment of the present invention executes, in a user terminal, the steps of: (a) receiving an advertisement selection input of a user; (b) acquiring terminal identification information of the user terminal; and (c) creating a cookie including the terminal identification information.

In addition, the application further executes the step of loading the created cookie and updating cookie information when the advertisement selection input of the user is received on a web browser.

On the other hand, an application according to still another embodiment of the present invention executes, in a user terminal, the steps of: (a) receiving an advertisement selection input of a user; (b) loading a previously created cookie; (c) acquiring terminal identification information of the user terminal; and (d) updating cookie information of the cookie, in which the cookie is created when a web page is connected on a web browser.

In addition, the application further executes the step of transmitting the cookie information included in the cookie.

### BRIEF DESCRIPTION OF THE DRAWINGS

FIG. 1 shows a view of providing cookie information to a server by a user terminal, and analyzing a web page connection pattern of the user terminal based on the cookie information and providing an advertisement appropriate to each terminal by the server.

FIG. 2 is a view showing a conventional problem of recognizing, when an application or a web browser is used on a user terminal, that the application or the web browser is used by a different subject and transmitting cookie information to the server by the user terminal.

FIG. 3 a view showing a first embodiment of a cookie information management method according to the present invention, which is performed when an advertisement is initially connected by an application.

FIG. 4 a view showing a second embodiment of a cookie information management method according to the present invention, which is performed when an advertisement is connected by a web browser after the advertisement is connected by an application.

FIG. 5 a view showing a third embodiment of a cookie information management method according to the present invention, which is performed when an advertisement is initially connected by a web browser.

FIG. 6 a view showing a fourth embodiment of a cookie information management method according to the present invention, which is performed when an advertisement is connected by an application after the advertisement is connected by a web browser.

FIG. 7 is a view showing a real example of terminal identification information or temporary identification information written in a cookie.

### DETAILED DESCRIPTION OF THE PREFERRED EMBODIMENT

Details of the objects and technical configuration of the present invention and operational effects according thereto will be more clearly understood by the detailed description described below based on the accompanying drawings attached in the specification of the present invention. The embodiments according to the present invention will be hereafter described in detail, with reference to the accompanying drawings.

The embodiments disclosed in this specification should not be interpreted or used to limit the scope of the present invention. It is natural that the description including the embodiments of this specification has various applications to those skilled in the art. Accordingly, certain embodiments disclosed in the detailed description of the present invention are for illustrative purposes to further clearly describe the present invention and are not intended to limit the scope of the present invention to the embodiments.

The function blocks shown in the figures and described below are merely examples of possible implementations. Accordingly, other components may be used in other implementations of the present invention without departing from the spirit and scope of the present invention. In addition, although one or more of the function blocks of the present invention are expressed an individual blocks, one or more of the function blocks of the present invention may be a combination of various hardware and software components executing the same function.

In addition, the expression of ‘including’ an element is an expression of an ‘open type’ which merely refers to existence of a corresponding component, and it should not be construed as precluding additional components.

It will be understood that when a constitutional component is referred to as being “connected” or “coupled” to another element, it may be directly connected or coupled to the other element or intervening elements may be present.

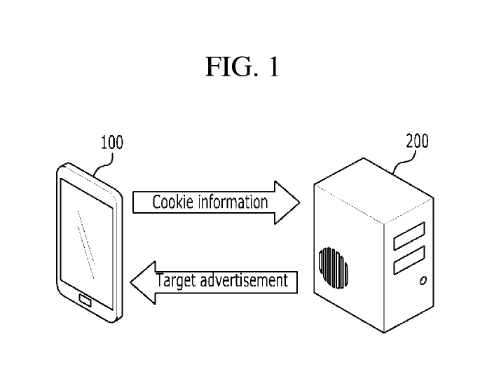

FIG. 1 is a view showing an interactive data transmission and reception relation between a user terminal 100 which creates and stores a cookie and a server 200 which collects cookie information included in the cookie and provides an appropriate advertisement.

First, a cookie is a kind of data stored in a portion of a memory area existing in a web browser, and such a cookie refers to a data consistently storing information when a user terminal 100 connects to a specific web page, i.e., when the user terminal 100 communicates with an external server.

Generally, a cookie is stored as a data of a very small size smaller than 4 KB in correspondence to a specific web page as described above.

The role of a cookie is memorizing the data input from a specific web page and loading cookie information when the user reconnects to the same web page to eliminate the need of deliberately re-inputting the data that has been input before, and, for example, the cookie may store a web page address connected in the past by the user terminal 100, and when connection to the same web page is attempted again later, even though only a part of the web page address is input, the other part of the web page address is invoked and displayed. Furthermore, in some cases, even an ID or a password can be displayed in advance without the need of inputting the ID or the password again.

Meanwhile, a subject creating the cookie may vary according to a path connecting to a web page, i.e., an advertisement, by the user on the user terminal 100.

That is, when an advertisement web page is connected through an application on the user terminal 100, i.e., when a banner advertisement, a full-page advertisement or the like displayed on a screen when the application is executed is clicked by a user, a cookie is created by a software development kit associated with the application.

Alternatively, when an advertisement web page is connected through a web browser on the user terminal 100, i.e., when a banner advertisement, a full-page advertisement or the like displayed on a web page while surfing the web using a web browser is clicked by a user, a cookie is created by a script of the web page.

Referring to FIG. 1 again, cookie information in the cookie created like this is transmitted to the server 200, and the server 200 collects various kinds of information to grasp a connection pattern of the user terminal 200. For example, the cookie information collected by the server 200 at this point may include an address of a web page connected through a clicked advertisement banner, and, in addition, a duration of time of connecting the user terminal 100 to a corresponding web page, web page connection information such as a category of a web page, an advertisement clicked by the user, an advertisement time and the like.

Meanwhile, the server 200 may store the collected cookie information in an internal database and use the cookie information to autonomously select an appropriate advertisement to be provided to each user terminal 100 or transfer the cookie information to a separate external advertisement server 200. Since the process of selecting an advertisement to be provided to each user terminal 100 is out of the scope of the present invention, details thereof will be omitted in this specification.

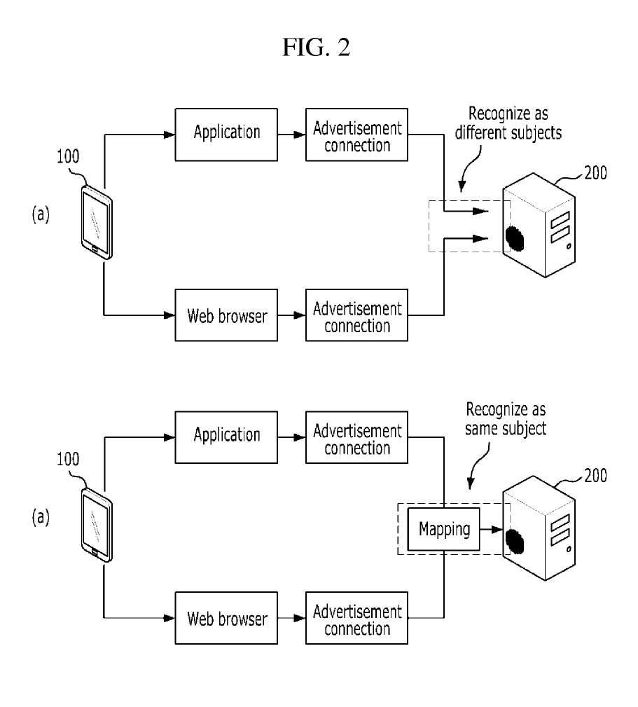

FIG. 2 is a view showing a comparison between a method of managing cookie information by a conventional user terminal 100 and a cookie information management method according to the present invention.

FIG. 2(a) shows a view of distinguishing a subject according to whether a web page is connected through an application or a web browser on a conventional user terminal 100 and separately transmitting cookie information to the server 200.

That is, as is described above in the background art, there is a problem in the prior art that although the same user terminal 100 connects to a web page, the user terminal 100 recognizes that the connection is established by a separate subject and transmits cookie information to the server 200 according to a path through which the connection is established since the user terminal 100 cannot integratedly manage the cookie information.

Meanwhile, there is a problem in that in the case of a cookie created by a software development kit when an application is executed, since the application can acquire identification information unique to the terminal (hereinafter, referred to as terminal identification information), the cookie can be created by including the terminal identification information as cookie information, whereas in the case of a cookie created through a script when a web page is connected using a web browser, since the terminal identification information cannot be acquired, a subject of corresponding cookie information cannot be specified although the cookie is created.

That is, in the case of connecting to a specific advertisement through an application on the user terminal 100, since terminal identification information is included in the cookie created at this point, the server 200 collecting cookie information can confirm a connection pattern of the user terminal 100, whereas in the case of connecting to a specific advertisement through a web browser on the user terminal 100, there is a problem in that the server 200 cannot identify at all a connection pattern belonging to the user terminal 100 since the terminal identification information is not included in the created cookie.

FIG. 2(b) is a view briefly showing a methodology which can solve the problems described above, and according to this, since the user terminal 100 includes both the cookie information created when an advertisement is connected through an application and the cookie information created when an advertisement is connected through a web browser, the problems described above can be solved by specifying a subject to one user terminal 100 and transmitting the cookie information to the server 200.

When the cookies created according to the use of an application and a web browser are integratedly managed on the user terminal 100, the server 200 can clearly grasp a connection pattern of the user terminal 100, and thus there is an effect of appropriately selecting advertisement contents to be transmitted to the user terminal 100 in the future.

In addition, when a cookie is created by the application, it can be implemented to transfer and store additional information of the terminal, such as a terminal IP address used by the terminal, a type of the communication company, a type of the operating system, a version of the operating system, a network, a language set in the terminal, a manufacturer of the terminal, a model name of the terminal, a resolution of the terminal, a type of the terminal and the like, in the external server 200 through the software development kit (SDK), and thus if a cookie created according to use of an application or a web browser is matched and managed on the user terminal 100, there is an effect of effectively performing a target advertisement since use of the cookie information on the web browser can also be matched to the additional information of the terminal.

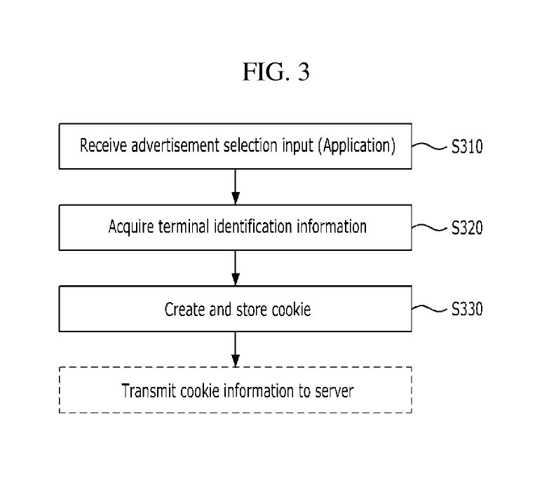

Hereinafter, a cookie information management method according to the present invention and an application for executing such a method on the user terminal 100 will be described with reference to FIGS. 3 to 6.

First of all, a process of initially creating a cookie when an advertisement web page is connected by an application will be described with reference to FIG. 3.

First, the user terminal 100 receives an advertisement selection input of a user on an application (step S310). At this point, the advertisement selection input refers to a behavior of the user selecting an advertisement link displayed when or during the application is executed, and this can be accomplished in the form of a touch or in a method of clicking a button on the terminal.

When the advertisement selection input of a user is received on the application, the user terminal 100 searches for and acquires terminal identification information of the user terminal 100 (step S320).

The terminal identification information refers to identification information of a numeric or character form which can distinguish a plurality of user terminals 100, and it may include a serial number of the terminal, a Unique Device ID (UDID), an advertisement identifier of each OS and the like. The UDID of the terminal is unique identification information assigned to the terminal, which refers to information created in a form combining at least any one piece of information including, for example, a serial number, a MAC address and the like. In addition, the advertisement identifier of each OS refers to identification information including, for example, characters or numerals assigned to each individual user or terminal by Android or iOS manufacturers, and the advertisement identifier is assigned by each OS manufacturer for the purpose of grasping a connection pattern of the user or the user terminal 100.

That is, the terminal identification information in this detailed description means all characters, numerals or a combination thereof which can specify any one of the user terminals 100.

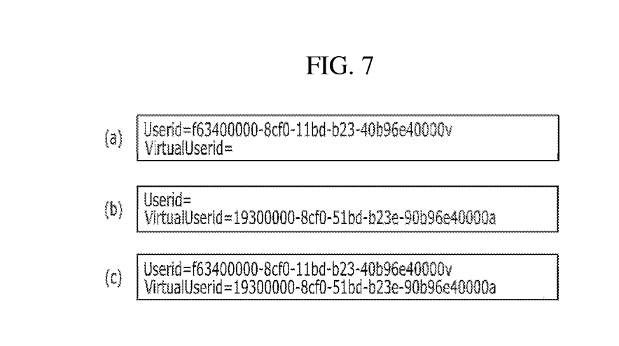

Meanwhile, after the terminal identification information is acquired, the user terminal 100 creates a new cookie including the acquired terminal identification information (step S330) and stores the cookie. In other words, the user terminal 100 inserts the terminal identification information in the cookie in the method described in FIG. 7(a) and stores the cookie in a specific space of the terminal.

At this point, although the apparatus which creates the cookie will be the user terminal 100, a subject which actually controls the apparatus will be an application, and the application makes the associated software development kit (SDK) create the cookie.

The cookie information in the cookie created and stored like this is transferred to the server 200 and utilized as a reference data for selecting a target advertisement in the future. In addition, at this point, the application can be implemented to acquire additional information of the terminal (a communication company, an operating system type, an operating system version or the like) and makes the software development kit (SDK) transfer the additional information to the external server 200 to be utilized as a reference data for selecting a target advertisement.

Meanwhile, in the embodiment of FIG. 3, step S320, i.e., the step of acquiring the terminal identification information, can be progressed regardless of the order mentioned above, and, for example, the terminal identification information of the user terminal can be acquired as soon as the user executes the application.

Meanwhile, in the embodiment of FIG. 3, after step S320, the cookie information management method may further include the step of confirming whether or not a previously created cookie corresponding to an advertisement clicked by the user and including temporary identification information exists in the user terminal.

If a previously created cookie does not exist, this means that a corresponding advertisement web page has been connected only by an application, and thus step S330 of FIG. 3 is progressed as is thereafter.

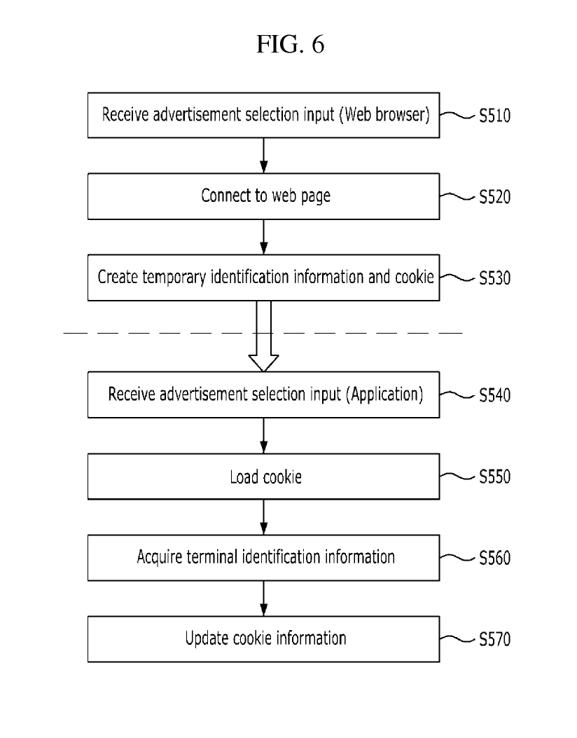

However, if a previously created cookie exists, this means that the advertisement web page has been connected through a web browser, and, in this case, the cookie information management method as shown in FIG. 6 is progressed.

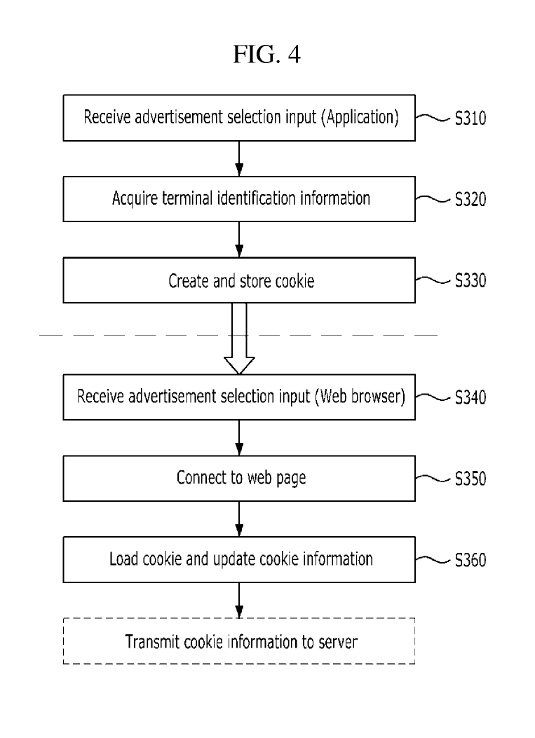

Meanwhile, FIG. 4 is an embodiment assuming the embodiment of FIG. 3, i.e., a case of connecting to an advertisement web page and creating a cookie on an application and then connecting to the same advertisement web page again through a web browser.

According to this, after the cookie including the terminal identification information is created before, the user terminal 100 receives an advertisement selection input of the user on the web browser (step S340). At this point, the advertisement selection input is a behavior of the user selecting an advertisement link displayed when or during the application is executed. In addition, it is assumed that the advertisement link selected at this point is connected to a web page the same as that of the advertisement link selected on the application before, i.e., both the advertisement links selected on the application and the web browser are connected to the same web page.

After step S340, the user terminal 100 connects to a corresponding web page in response to the received advertisement selection input (step S350) and performs a next step according to a script instruction of the web page.

That is, the user terminal 100 loads the cookie created before by execution of the application after connecting to the advertisement web page and updates the corresponding cookie by overwriting new cookie information on the cookie (Step S360). At this point, although it will be the user terminal 100 which physically writes the cookie information, the script will actually control the user terminal 100, and instructions included in the script instruct the user terminal 100 to load the cookie and update the cookie with new cookie information.

It is understood that according to the prior art, although a cookie is created by executing an application, a separate cookie (not including terminal identification information) will be created when the advertisement web page is connected by executing a web browser, whereas according to the present invention, cookie information can be recorded through a cookie including the terminal identification information even when an advertisement connection is established through a web browser by loading the cookie created by the execution of an application in the prior art and updating the cookie.

That is, a corresponding user terminal 100 can be specified even when an advertisement connection is established through a web browser.

Meanwhile, after step S360, the user terminal 100 will transmit the cookie information to the server 200 under the control the application, and, at this point, as is described above in FIG. 3, the application may acquire additional information of the terminal (a communication company, an operating system type, an operating system version or the like), in addition to the cookie information, and have the software development kit (SDK) transmit the additional information to the external server 200.

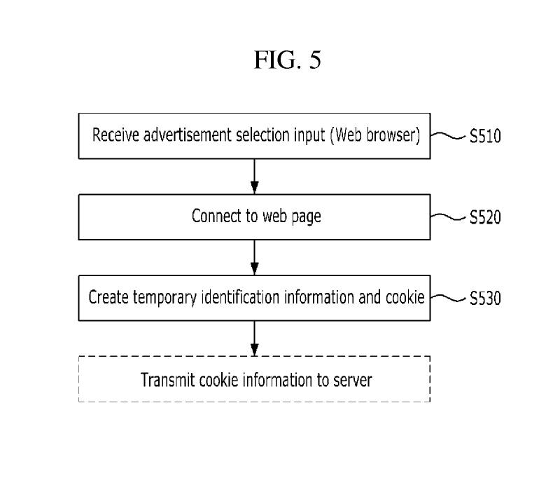

Next, a process of initially creating a cookie when an advertisement web page is connected by a web browser will be described with reference to FIG. 5.

According to FIG. 5, first, the user terminal 100 receives an advertisement selection input of a user on a web browser (step S510). At this point, the advertisement selection input is actually the same as that described above in the description of FIG. 3, and it refers to a behavior of the user selecting a banner advertisement, a full-page advertisement or the like displayed when or during the web browser is executed.

When the advertisement selection input of the user is received on the web browser, the user terminal 100 connects to a web page corresponding to the advertisement selection input (step S520).

Meanwhile, after connecting to the web page at step S520, the user terminal 100 is controlled according to the script instructions included in the web page, and, particularly, at this point, the user terminal 100 temporarily creates identification information (hereinafter, referred to as temporary identification information) for specifying the corresponding user terminal 100 and creates a cookie including the temporary identification information (step S530).

That is, since unique identification information of a corresponding user terminal 100 cannot be collected as described above when a cookie is created by connection to a web page, in the present invention, the user terminal 100 can be specified by assigning temporary identification information to the user terminal 100 to solve the problem.

The temporary identification information created at this point is configured of a combination of random numerals and characters, and FIG. 7(b) shows an example of writing the temporary identification information in a cookie.

On the other hand, as is understood from FIG. 7(b), since the terminal identification information of the user terminal 100 cannot be obtained when the user terminal 100 connects to an advertisement web page only through a web browser, it can be confirmed that the terminal identification information is displayed as null.

In addition, at this point, although the apparatus which creates the cookie will be the user terminal 100, it should be understood that control of the apparatus is actually accomplished according to the script instructions in the web page.

Meanwhile, in the embodiment of FIG. 5, after step S520, the cookie information management method may further include the step of confirming whether or not a previously created cookie corresponding to an advertisement clicked by the user and including terminal identification information exists in the user terminal.

If a previously created cookie does not exist, this means that a corresponding advertisement web page has been connected only by a web browser, and thus step S530 of FIG. 5 is progressed as is thereafter.

However, if a previously created cookie exists, this means that the advertisement web page has been connected through an application, and, in this case, the cookie information management method as shown in FIG. 4 is progressed.

Meanwhile, FIG. 6 is an embodiment assuming the embodiment of FIG. 5, i.e., a case of connecting to an advertisement web page through an application after a cookie is created according to connection to the same advertisement web page on a web browser.

According to this, after the cookie including the temporary identification information is created before, the user terminal 100 receives an advertisement selection input of the user on the application (step S540). At this point, the advertisement selection input is assumed to be connected to a web page the same as that of the advertisement link selected on a web browser.

After step S540, the user terminal 100 loads the cookie created before according to the web page connection (step S550).

Meanwhile, reminding that the terminal identification information of the user terminal 100 can be acquired during an application is executed, the user terminal 100 acquires the terminal identification information of the user terminal 100 (step S560) after loading the cookie at step S550 and updates the cookie information (step S570) by overwriting the acquired terminal identification information on the loaded cookie.

Meanwhile, it should be understood that the step of loading the cookie and the step of acquiring the terminal identification information in the embodiment described above do not need to necessarily follow the order described above, and the order can be changed according to the intention of a designer.

In addition, at this point, although it will be the user terminal 100 which physically writes the cookie information, a subject which actually controls the apparatus will be an application, and the application makes the associated software development kit (SDK) update the cookie.

An example of a cookie after the cookie information is updated is disclosed in FIG. 7(c). That is, in the case of an embodiment according to FIG. 6, it can be confirmed that both the temporary identification information according to a web page connection on a web browser and the terminal identification information of a corresponding user terminal 100 acquired when a web page is connected on the application are recorded in the cookie.

Meanwhile, when the application records the acquired terminal identification information in the cookie, it maps the terminal identification information to the temporary identification information, and, at this point, the mapping means grouping the two pieces of identification information by matching so that the identification information can be recognized as a user terminal 100 even when any identification information is referenced.

Meanwhile, after step S570, the user terminal 100 will transmit the cookie information of the updated cookie to the external server 200 under the control the application and, furthermore, may also transmit additional information of the terminal (a communication company, an operating system type, an operating system version or the like) together with the cookie information.

A method of managing cookie information on the user terminal 100 is described above with reference to FIGS. 3 to 6. However, although the cookie information management method has been described above focusing on the steps performed by the user terminal 100 as a subject, it should be understood that each of the steps is performed by controlling the user terminal 100 by an application and a script created in software.

That is, an application, which is still another implementation form of the present invention, may execute the steps of receiving an advertisement selection input of a user on the user terminal 100; acquiring terminal identification information of the user terminal 100; and creating a cookie including the terminal identification information and, furthermore, further execute the step of loading the created cookie and updating cookie information when an advertisement selection input of the user is received on a web browser after the cookie is created. In addition, at this point, it should be naturally understood that the application may include a software development kit (SDK).

In addition, when a cookie is created as soon as a web page is connected on a web browser, the application according to the present invention may execute the steps of receiving an advertisement selection input of a user on a user terminal 100; loading the previously created cookie; acquiring terminal identification information of the user terminal 100; and updating cookie information of the cookie.

According to the present invention, it is effective in that web page connection information on a web browser, as well as web page connection information on an application, can be managed through a cookie.

Furthermore, according to the present invention, it is effective in that web page connection through an application and web page connection through a web browser on a user terminal can be specified to be established by one subject, not by separate subjects.

In addition, it is effective in that since information on a web page connection established through an application and information on a web page connection established through a web browser are specified to be created by one user terminal and the connection information can be shared, information on the web page connection established through the web browser also can be utilized as a reference data for marketing.

Although the preferred embodiments and application examples of the present invention have been disclosed for illustrative purposes, the present invention is not limited to the specific embodiments and application examples described above, and those skilled in the art will appreciate that various modifications, additions and substitutions are possible, without departing from the scope and spirit of the invention as disclosed in the accompanying claims. These modifications, additions and substitutions are should not be understood as being separate from the technical spirits and prospect of the present invention n.

What is claimed is:

1. A method of managing cookie information, at a user terminal, the method comprising the steps of:
(a) receiving an advertisement selection input of a user for a specific advertisement, on an application of the user terminal;
(b) acquiring terminal identification information of the user terminal;
(c) confirming whether or not a previously created cookie corresponding to the advertisement and including temporary identification information exists in the user terminal;
wherein if a previously created cookie exists, step (c) loads the previously created cookie, conducts mapping of the terminal identification information and the temporary identification information, and updates the cookie information by recording the mapped terminal identification information in the cookie.

2. The method according to claim 1, wherein if a previously created cookie does not exist, step (c) creates a new cookie including the terminal identification information.

3. The method according to claim 1, wherein the terminal identification information includes at least any of a serial number, a Unique Device ID (UDID) and an advertisement identifier of each OS.

4. The method according to claim 1, wherein the step of acquiring terminal identification information of the user terminal further acquires additional information of the user terminal including at least any one of an IP address of the terminal, a communication company, a type of an operating system, a version of the operating system, a network, a language set in the terminal, a manufacturer of the terminal, a model name of the terminal, a resolution of the terminal and a type of the terminal.

5. The method according to claim 1, wherein the cookie is created by a control command of a software development kit installed in the user terminal.

6. The method according to claim 1, further comprising the step of transmitting the cookie information included in the cookie.

7. The method according to claim 6, wherein the cookie information includes web page connection information or advertisement connection information.

8. A method of managing cookie information, at a user terminal, the method comprising the steps of:
(a) receiving an advertisement selection input of a user for a specific advertisement, on a web browser of the user terminal;
(b) connecting to a web page corresponding to the advertisement selection input; and
(c) confirming whether or not a previously created cookie corresponding to the advertisement and including terminal identification information exists in the user terminal;
wherein if a previously created cookie exists, step (c) loads the previously created cookie, conducts mapping of the temporary identification information and the terminal identification information, and updates the cookie information by recording the mapped temporary identification information in the cookie.

9. The method according to claim 8, wherein if a previously created cookie does not exist, step (c) creates a new cookie including the temporary identification information.

10. The method according to claim 8, wherein the terminal identification information includes at least any of a serial number, a Unique Device ID (UDID) and an advertisement identifier of each OS.

11. The method according to claim 8, wherein the cookie is created by a control command of a script when the web page corresponding to the advertisement selection input is connected.

12. The method according to claim 8, further comprising the step of transmitting the cookie information included in the cookie.

13. The method according to claim 12, wherein the cookie information includes web page connection information or advertisement connection information.
